(19) United States
(12) Patent Application Publication
(10) Pub. No.: US 2019/0005677 A1
(43) Pub. Date: Jan. 3, 2019

(54) LIGHT SOURCE ESTIMATION

(71) Applicant: Intel IP corporation, Santa Clara, CA (US)

(72) Inventor: Oliver Grau, Volklingen (DE)

(21) Appl. No.: 15/636,370

(22) Filed: Jun. 28, 2017

(51) Int. Cl. G06T 7/73; H04N 5/235

(52) U.S. Cl. CPC G06T 7/74; G06T 2207/30244; H04N 5/2351

(57) ABSTRACT

A method and apparatus for light source estimation are disclosed. In one embodiment, the apparatus comprises: an on-board tracking device to obtain a position and an orientation of a mobile device at a number of different times; one or more image sensors of the mobile device operable to capture a plurality of light probes of a scene from different positions and orientations at the number of different times; and a light source position determination processor coupled to receive the plurality of light probes and the position and orientation of the mobile device and operable to determine positions of discreet light sources of the scene using the plurality of light probes and the position and orientation of the mobile device.

### FIELD OF THE INVENTION

Embodiments of the present invention relate to the field of light source estimation in a real-world environment; more particularly, embodiments of the present invention relate to determining locations of discreet light sources using multiple light probes taken with sensors or cameras on the same device.

### BACKGROUND OF THE INVENTION

Recently produced algorithms and software may be used to render synthetic objects into real-world scenes. Oftentimes, a piece of furniture, a prop, a digital creature or an actor needs to be rendered seamlessly into a real scene. This task requires that the objects be lit consistently with the surfaces in their vicinity, and that the interplay of light between the objects and their surroundings be properly simulated.

One technique for rendering synthetic objects into scenes uses high dynamic range images and allows measurements of scene radiance to be derived from a set of differently exposed images. The technique allows both low levels of indirect radiance from surfaces and high levels of direct radiance from light sources to be accurately recorded. When combined with image-based modeling and rendering techniques such as view interpolation, projective texture mapping, and possibly active techniques for measuring geometry, these derived radiance maps can be used to construct spatial representations of scene radiance. However, one problem with such a technique is that the light information is captured for a room in separate steps from light probing devices (e.g., digital single-lens reflex(DSLR) cameras) and then requires offline processing.

Mobile devices have been used to capture light information. However, such mobile devices have only been used to capture very rough ambient light at the position of the mobile device which is used, for example, to color-balance the built-in camera of the mobile device. This approach does not cope with more challenging situations like mixed lighting.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates an example of an environment having a number of discreet light sources.

FIG. 2 illustrates one embodiment of a mobile device with multiple cameras and sensors that may be used to capture light probes and sensor data.

FIG. 3 illustrates one embodiment of a computing system to perform light source position estimation.

FIG. 4 illustrates one embodiment of a process for determining the locations of discreet light sources in an environment.

FIG. 5 is a block diagram of a mobile device 10 in accordance with one implementation.

### DETAILED DESCRIPTION

In the following description, numerous details are set forth to provide a more thorough explanation of the techniques disclosed herein. It will be apparent, however, to one skilled in the art, that the techniques may be practiced without these specific details. In other instances, well-known structures and devices are shown in block diagram form, rather than in detail, in order to avoid obscuring the inventive techniques.

In one embodiment, estimating light sources is performed by capturing the light situation in an environment using a mobile device. In one embodiment, the mobile device includes built-in imaging sensors such as, for example, cameras, ambient light sensors (ALSs) and records positional information of the mobile device to build a three-dimensional (3-D) mapping of the lighting situation. The 3-D mapping indicates the locations of the light sources. In one embodiment, the positional information comprises tracking information that is indicative of the location and orientation of the mobile device in the environment, and this information is recorded when each image is captured.

In one embodiment, the techniques described herein estimate full parametric 3D light sources to facilitate a number of applications, such as, for example, realistic mixing of virtual and real scene elements in augmented reality or visual effects. The full parametric 3D light sources may also be used in a second application to provide a more accurate solution for color balancing under mixed-lighting conditions, thereby enabling better quality photography on mobile devices.

In one embodiment, the lighting situation is captured using light probes. A light probe is a high-dynamic range (HDR) image of the environment. In prior art approaches, the HDR images are taken either by photographing a metal ball or by direct capture with a fisheye lens. While these capture devices may be used, the techniques described herein are not limited of using a metal ball or a fisheye lens.

In one embodiment, estimating the locations of light sources in a scene is performed using multiple features. First, the light situation is captured from many positions using a capture device. Using this information, the position and fall-off characteristics of the light sources are estimated. Second, the position and orientation of the light capture are determined with ‘on-board’ capabilities of the capture device. In one embodiment, for mobile personal computers (PCs), this is accomplished with well-known device tracking techinques. For example, in one embodiment, the on-board device tracking uses Simultaneous Localization and Mapping (SLAM) methods. Other techniques include, for example, but not limited to, the use of an active tracker with light emitting diode (LED) emitters and sensors such as is used with the virtual reality (VR) devices, radio-frequency positioning, etc. Third, in one embodiment, the derived discreet light source models are compatible with most 3D rendering systems and not restricted to ray-tracing approaches as in prior art approaches. Fourth, in one embodiment, one or more ambient light sensors (ALSs) is used for faster capture and can be achieved without multiple images. In one embodiment, these features are implemented on a mobile device, such as a mobile personal computer (PCs), including form factors like notebooks, tablet, smartphones, etc., with the required sensors, such as, for example, image sensors for camera and an ALS.

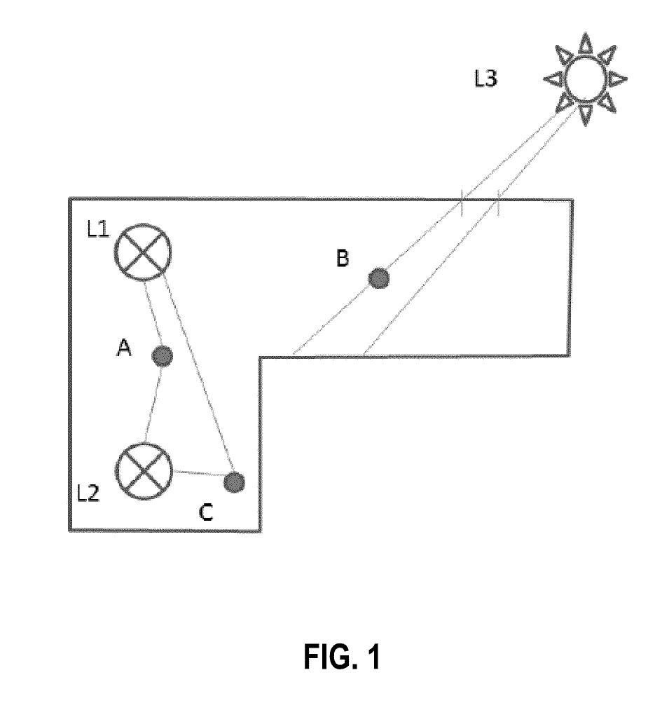

In one embodiment, the estimation of discreet light sources is performed by sampling the scene from different positions, thereby allowing estimation of the position of light sources, like a lamp in a room. FIG. 1 illustrates an example of an environment having a number of discreet light sources. Referring to FIG. 1, light sources L1-L3 provide light. Light sources L1 and L2 are within a structure (e.g., a building or room) while light source L3 is the sun that shines light in through a window in the structure. The mobile device is placed at positions A, B and C in the structure and light probes are captured at positions A, B and C in the structure using one or more images sensors (e.g., cameras) of the mobile device. In one embodiment, the cameras includes a fisheye lens to capture an image of 180°. In one embodiment, multiple images are captured at each location. For example, one would take either randomly many images or ‘sample’ the space such that, for example, two images at taken with a 180° fisheye lens to capture a 360° view.

When the light probes are being captured, the position and orientation of the mobile device is determined and stored in memory in the mobile device. In one embodiment, the position and orientation are stored with the light probe captured for that location. In one embodiment, the position and orientation are captured using an on-device tracking system that is on the mobile device. In one embodiment, the on-device tracking system uses a SLAM method for tracking the position and orientation of the mobile device while simultaneously constructing or updating a map of an unknown environment in which the light probes are being captured. There are a number of well-known SLAM methods. In one embodiment, the SLAM method uses camera images from the mobile device to perform visual SLAM (VSLAM) using primarily visual (camera) sensors. Other known SLAM methods can include other types of sensors (e.g., inertial sensors, accelerometers, magnetometers, optical sensors, gyroscopes, global positioning system (GPS) sensors (e.g. GPS devices such as GPS chips), visual sensors, LIDAR sensors, laser rangefinders, sonar sensors, etc.). Different SLAM algorithms use data from different types of sensors.

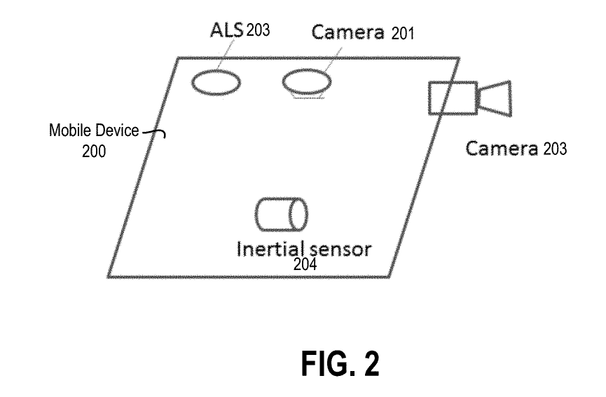

FIG. 2 illustrates one embodiment of a mobile device with multiple cameras and sensors that may be used to capture light probes and sensor data. Referring to FIG. 2, mobile device 200 includes cameras 201 and 202, along with ambient light sensor (ALS) 203 and inertial sensor 204. In one embodiment, cameras 201 and 202 and ALS 203 and inertial sensor 204 provide data to allow processing logic (e.g., processors, circuitry, software, firmware, etc.) on the mobile device (not shown) or outside of the mobile device (not shown) to determine each light source in an environment discreetly and independently.

In one embodiment, the location of the discreet light sources is performed by using triangulation of light sources detected in multiple high dynamic range (HDR) images and using sensor data from an ambient light sensors (ALS) of the mobile computing device. The ALS is able to estimate to total incoming light level with one reading and hence is real-time capable and does not require set-ups with, for example, tripods to capture HDR images.

In one embodiment, the positions of discreet light sources of a scene are estimated according to the following. First, the position X and orientation O of the capture (or light probing) device are determined and stored in memory. In one embodiment, this is performed using on-device registration. This may be performed using a SLAM method in conjunction with data from one or more on-board camera and one or more sensors (e.g., inertial sensors). In one embodiment, the capture device comprises a mobile device that may be moved to different positions and orientations. At each position X and orientation 0, the capture device captures a HDR light probe. The light probe is stored in memory. The determination and storage of the position X and orientation O of the capture device along with the capturing of an HDR light probe at each location of the capture device is repeated for a number of different positions and orientations (e.g., positions A, B, and C of FIG. 1). Using the captured light probes, the position of light sources (e.g., L1, L2, etc. in FIG. 1) is performed. In one embodiment, this is performed by triangulation. Performing triangulation using captured light probes is well-known in the art. For more information on calculating the light source positions via triangulation, for example, see Einabadi, et al., “Discrete Light Source Estimation from Light Probes for Photorealistic Rendering,” Proc. of the British Machine Vision Conference (BMVC), pgs. 43.1-43.10, Swansea, UK, September 2015 (herein the “Einabadi paper”). The Einabadi paper also describes a method on how the fall-off characteristic of a light can be modelled and estimated from multiple light-probes. In particular, spot lights have a bright cone in one direction, usually highest intensity in the middle and then the intensity falls off with increasing angle from the main axis. By taking multiple light-probe samples at different positions of the light beam, the fall-off characteristic can be estimated by fitting, e.g. a polynomial approximation of the light source intensity as a function of the angle to the light's main axis. Note that in one embodiment, a theoretical minimum of 3 light probes are used for quadratic function, practically a higher number of samples are used, e.g. 10-20. The intensity is determined by integration (by summation) of the pixel intensities in the light probe identified and assigned to the light source.

In one embodiment, the light source position estimation also determines fall-off characteristics of light sources by fitting a fall-off curve into a set of data from an ambient light sensor on the capture device, which measures the total incoming light. For the simple case of only one light source, the ambient light sensor gives the equivalent measure of the integrated pixel sum of the light probe method described above (the Einabadi paper). In one embodiment, one method used herein separates the light sources, e.g. by triangulation from camera images (not necessarily HDR). Then the intensities are estimated and optionally the fall-off characteristics are estimated by data fitting to multiple readings of the ambient light sensor taken from different positions. Since this is a very under-constrained set-up, it requires a lot of samples (practically more in the order of hundreds or thousands).

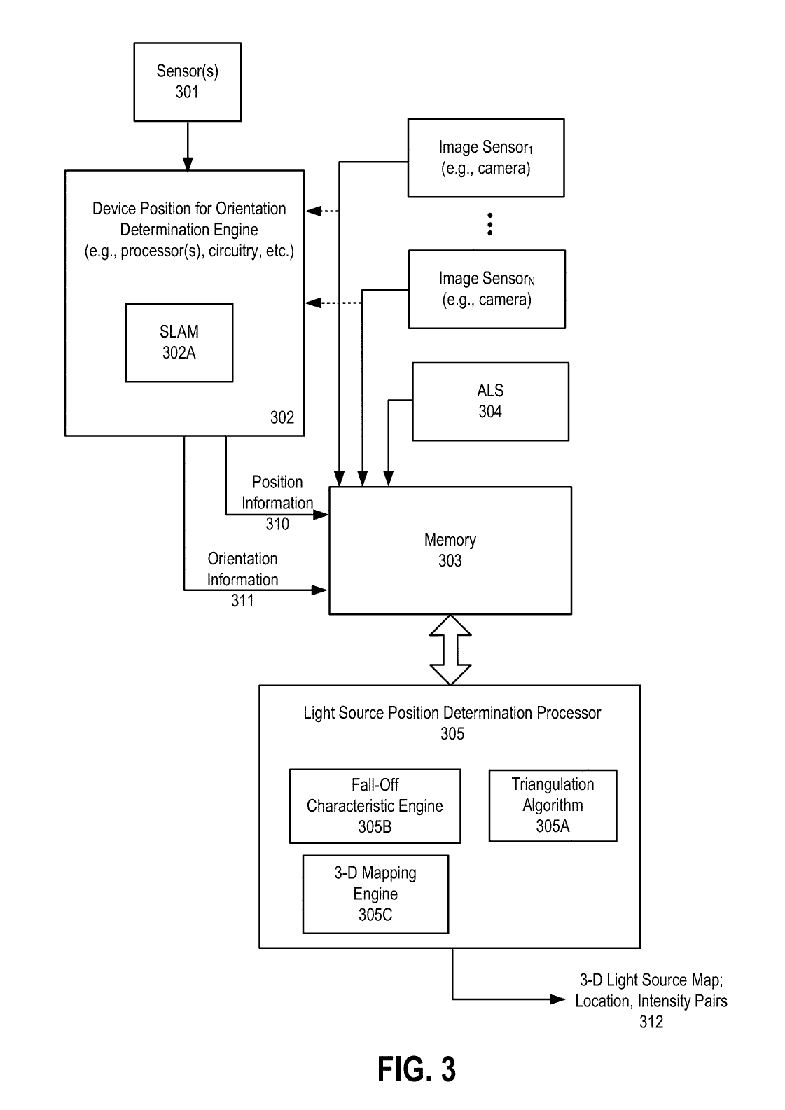

FIG. 3 illustrates one embodiment of a computing system to perform light source position estimation. The components of the computing system may comprise hardware (circuitry, dedicated logic, etc.), software (such as is run on a general purpose computer system or a dedicated machine), firmware, or a combination of the three. In one embodiment, the computing system comprises a mobile device, such as, a mobile personal computer (PC), notebook, tablet, smartphone, personal digital assistant (PDA), etc.

Referring to FIG. 3, image sensors_{1-N} (e.g., cameras) of the mobile device capture one or more light probes of a scene while the mobile device is positioned in an environment. The captured light probe images are stored in memory 303.

When light probes are being captured, device position and orientation determination engine 302 determines the position and orientation of the mobile device. In one embodiment, this is based on data from one or more sensors 301 and/or camera images from image sensors 1-N (e.g., cameras). In one embodiment, device position and orientation determination engine 302 determines the position and orientation of the mobile device using a SLAM method. Note that methods other than SLAM may be used by device position and orientation determination engine 302 to determine the position and orientation of the mobile device.

After determining the position and orientation of the mobile device, device position and orientation determination engine 302 sends position information 310 and orientation information 311 to memory 303. In one embodiment, position information 310 and orientation information 311 are stored in memory with the light probes that were captured while the mobile device was in that position.

ALS 304 measures the ambient light at each of the positions of the mobile device and the ambient light measurement is stored in memory 303 as well. In one embodiment, the ambient light measurement is stored with position information 310 and orientation information 311 and the light probes that were captured while the mobile device was in that position.

Note that memory 303 may be one or more distinct memories.

Light source position determination processor 305 (e.g., a processor, system-on-chip (SoC), digital signal processor (DSP)) obtains the light probes from memory 303 and determines the positions of the light sources in the scene from which the light probes were captured. In one embodiment, light source position determination processor 305 determines the positions of the light sources in the scene using triangulation as a result of executing triangulation algorithm 305A.

In one embodiment, light source position determination processor 305 also determines fall-off characteristics of the light sources. This is done using fall-off characteristics engine 305B being run by light source position determination processor 305.

In one embodiment, light source position determination processor 305 also determines a 3-D mapping of the light sources. This may be performed by using 3-D mapping engine 305C, which creates a 3-D map of the location of the light sources in the scene determined from the light probes.

Light source position determination processor 305 outputs information 312 indicative of the positions of the light sources in an environment. In one embodiment, output information 312 comprises a list of light sources and their locations. In another embodiment, output information 312 comprises a 3-D light source map or a depiction of the light sources located in their environment. In yet another embodiment, output information 312 comprises a list of light source locations with the light source intensity of each of the light sources. Note that subsets of the information in output information 312 may be output by light source position determination processor 305 as well.

Note that portions of FIG. 3 may be implemented outside of the mobile device. For example, in one embodiment, light source position determination processor 305 may be located outside mobile device. In such a case, the camera images, sensor data and mobile device position and orientation data are accessed by and/or sent to light source position determination processor 305 to enable it to determine the light source positions, as well as the intensity associated with each light source. Similarly, device position and orientation determination engine 302 may be located outside mobile device. In such a case, the sensor data is accessed by and/or sent to device position and orientation determination engine 302 to enable it to determine the position and orientation of the mobile device.

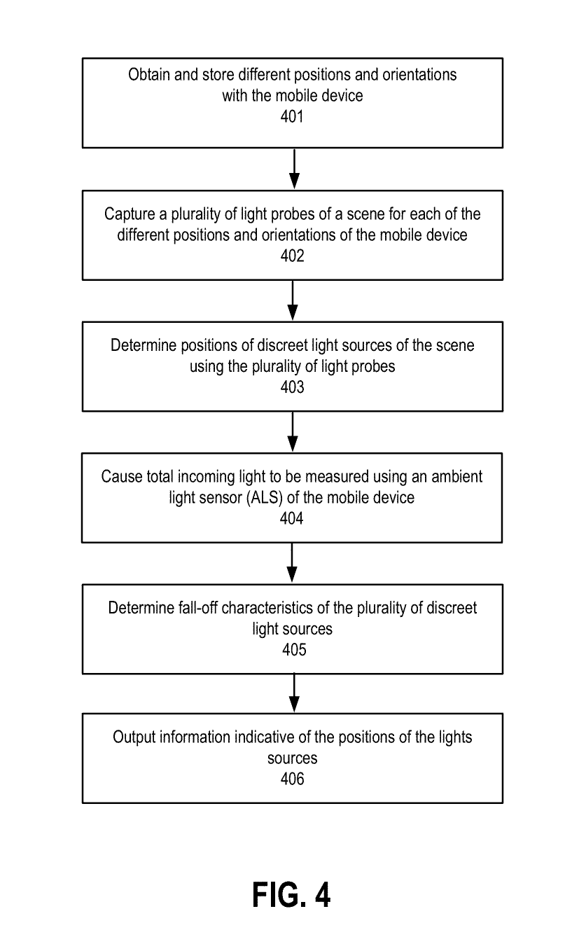

FIG. 4 illustrates one embodiment of a process for determining the locations of discreet light sources in an environment. In one embodiment, the process is performed by processing logic that may comprise hardware (circuitry, dedicated logic, etc.), software (such as is run on a general purpose computer system or a dedicated machine), firmware, or a combination of the three. In one embodiment, the process is performed by a mobile device (e.g., a mobile personal computer, a notebook computer, a tablet, a smartphone, etc.).

Referring to FIG. 4, the process starts with processing logic obtaining and storing different positions and orientations with the mobile device (processing block 401). In one embodiment, the different positions and orientations of the mobile device are obtained by performing simultaneous localization and mapping (SLAM). In one embodiment, performing SLAM occurs using sensor data from one or more sensors (e.g., inertial sensor(s), accelerometer(s), gyroscope sensor(s), magnetometer sensor(s), etc.) in a manner well-known in the art.

Processing logic also captures a plurality of light probes of a scene for each of the different positions and orientations of the mobile device (processing block 402). The light probes are captured using image sensors (e.g., cameras) on the mobile device. In one embodiment, the light probe images are high dynamic range (HDR) images. In one embodiment, the capture of the light probes occurs at the same time or very near in time to the recording of the mobile device position and orientation. This may occur by using a trigger that causes the camera(s) to capture an image at the same time the mobile device determines its position and orientation. The trigger may be engaged based on an application that is running on the mobile device. For example, the mobile device may be running an application that is going to produce and/or use the locations of the light sources in a scene in an environment. This application may cause the position and orientation of the device to be recorded when a camera button or other user interface element is used to capture an image of the environment. In another embodiment, after positioning the mobile device to capture an image of the scene, a user interface element (e.g., button) may be selected that causes both the camera(s) to record the light probes and the mobile devices position and orientation to be recorded. Note that such triggers and/or application control may be used to cause ambient light sensors (ALSs) of the mobile device to capture the ambient light in the environment.

Each light probe and the associated position and orientation of the mobile device when the light probe was captured may be stored together or in a manner that allows them to be accessed for use when determining the locations of the light sources in the environment.

After capturing the light probes and the associated position and orientation of the mobile device when capturing the light probes, processing logic determines positions of discreet light sources of the scene using the plurality of light probes (processing block 403). In one embodiment, determining positions of discreet light sources of the scene is performed by triangulation of the discreet light sources detected in the plurality of light probes. In one embodiment, this is achieved by segmenting and grouping pixels in a light probe that belong to a light source (the Einabadi paper). The center of the pixel region is then back-projected into 3D space by using the registered camera parameters of the light probe (can be derived from a static calibration of the light-probing fisheye and the external orientation as given by the device tracking). From a minimum of two back-projected pixel centers, the position of the light source follows as the intersection (or closed foot point) of the back-projected rays.

Processing logic also causes total incoming light to be measured using an ambient light sensor (ALS) of the mobile device (processing block 404). In one embodiment, the data from the ambient light sensor is an intensity value indicative of the intensity of the light in the scene being captured by the ALS.

Using the data captured by the ambient light sensor, processing logic determines fall-off characteristics of the plurality of discreet light sources (processing block 405). In one embodiment, determining fall-off characteristics of the plurality of discreet light sources comprises fitting a fall-off curve into measurement data indicative of a measure of total incoming light made by an ambient light sensor of the mobile device.

Processing logic outputs information indicative of the positions of the lights sources (processing block 406). In one embodiment, the output information comprises a 3-D light source map. Such a light source map may be created as part of the on-device tracking that produces a map of the positions and orientations of the mobile device when capturing the light probes. This may be created using a 3-D mapping engine as described above. In another embodiment, the output information includes a location of each light source and information that indicates the intensity of the lights source. Such information may be output as light source/intensity pairs. In one embodiment, this information is provided to 3D rendering systems and/or virtual and augmented reality applications.

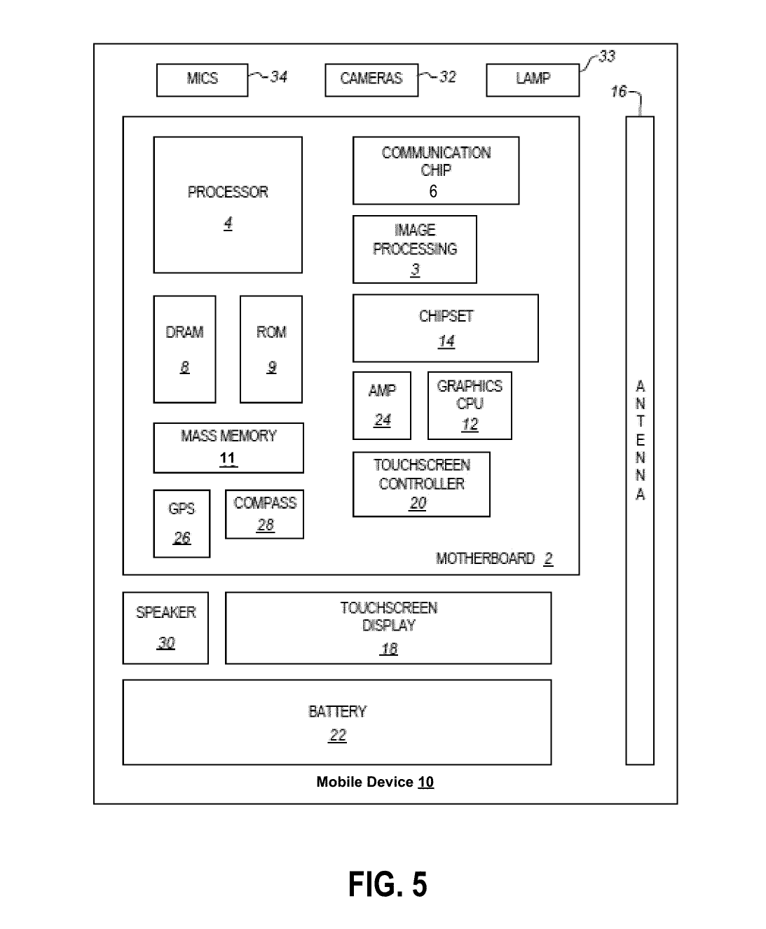

FIG. 5 is a block diagram of a mobile device 10 in accordance with one implementation. The mobile device 10 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, mobile device 10 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a lamp 33, a microphone array 34, and a mass storage device (such as a hard disk drive) 11, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the mobile device 10. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The mobile device 10 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The cameras 32 contain image sensors with pixels or photodetectors as described herein. The images may be used as described above. The image sensors may also use the resources of an image processing chip 3 to read values and also to perform exposure control, depth map determination, format conversion, coding and decoding, noise reduction and 3D mapping, etc. The processor 4 is coupled to the image processing chip to drive the processes, set parameters, etc. In various embodiments, the system includes a neural network accelerator in the image processing chip 3, the main processor 4, the graphics CPU 12, or in other processing resources of the system. The neural network accelerator may be coupled to the microphones through an audio pipeline of the chipset or other connected hardware to supply audio samples to the neural network accelerator as described herein. The operation of the neural network accelerator may be controlled by the processor to change weights, biases, and registers to operate in the manner described herein for speech recognition.

In one embodiment, other sensors such as the sensors discussed above, including ALS sensors, are included as well in the mobile device 10.

In various implementations, the mobile device 10 may be eyewear, a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, a digital video recorder, wearables or drones. In further implementations, the mobile device 10 may be any other electronic device that processes data.

There are a number of example embodiments described herein.

Example 1 is an apparatus comprising: an on-board tracking device to obtain a position and an orientation of a mobile device at a number of different times; one or more image sensors of the mobile device operable to capture a plurality of light probes of a scene from different positions and orientations at the number of different times; and a light source position determination processor coupled to receive the plurality of light probes and the position and orientation of the mobile device and operable to determine positions of discreet light sources of the scene using the plurality of light probes and the position and orientation of the mobile device.

Example 2 is the apparatus of example 1 that may optionally include that the light source position determination processor determines positions of discreet light sources of the scene by performing triangulation of the discreet light sources detected in the plurality of light probes.

Example 3 is the apparatus of example 1 that may optionally include an ambient light sensor of the mobile device operable to measure total incoming light using an ambient light sensor of the mobile device.

Example 4 is the apparatus of example 1 that may optionally include that a light intensity estimator to determine the light intensity of each of the discreet light sources.

Example 5 is the apparatus of example 4 that may optionally include that the light intensity estimator determines the light intensity by determining fall-off characteristics of the plurality of discreet light sources.

Example 6 is the apparatus of example 5 that may optionally include that the light intensity estimator determines the fall-off characteristics of the plurality of discreet light sources by fitting a fall-off curve into measurement data indicative of a measure of total incoming light made by an ambient light sensor of the mobile device.

Example 7 is the apparatus of example 1 that may optionally include that the on-board tracking device is operable to obtain the different positions and orientations with the mobile device using visual features and one or more cameras.

Example 8 is the apparatus of example 1 that may optionally include one or more sensors of a mobile device coupled to the registration device to determine orientation of the mobile device; and a position device coupled to the registration device to determine position of the mobile device.

Example 9 is the apparatus of example 8 that may optionally include that the one or more sensors comprises at least one accelerometer and a magnetometer and the position device comprises a global position system (GPS) device.

Example 10 is the apparatus of example 1 that may optionally include that the mobile device comprises one selected from a group consisting of: a mobile personal computer, a notebook computer, a tablet and a smartphone.

Example 11 is a method comprising: capturing a plurality of light probes of a scene from a number of different positions and orientations of a mobile device, including registering the different positions and orientations with the mobile device; and determining positions of discreet light sources of the scene using the plurality of light probes.

Example 12 is the method of example 11 that may optionally include that determining positions of discreet light sources of the scene is performed by triangulation of the discreet light sources detected in the plurality of light probes.

Example 13 is the method of example 11 that may optionally include measuring total incoming light using an ambient light sensor of the mobile device.

Example 14 is the method of example 11 that may optionally include determining fall-off characteristics of the plurality of discreet light sources.

Example 15 is the method of example 14 that may optionally include that determining fall-off characteristics of the plurality of discreet light sources comprises fitting a fall-off curve into measurement data indicative of a measure of total incoming light made by an ambient light sensor of the mobile device.

Example 16 is the method of example 11 that may optionally include that registering the different positions and orientations with the mobile device comprises performing on-board tracking with the mobile device.

Example 17 is the method of example 11 that may optionally include that the light probes are high dynamic range (HDR) images.

Example 18 is the method of example 11 that may optionally include that the mobile device comprises one selected from a group consisting of: a mobile personal computer, a notebook computer, a tablet and a smartphone.

Example 19 is an article of manufacture having one or more non-transitory computer readable storage media storing instructions which when executed by a system causes the system to perform a method comprising: capturing a plurality of light probes of a scene from a number of different positions and orientations of a mobile device, including registering the different positions and orientations with the mobile device; and determining positions of discreet light sources of the scene using the plurality of light probes.

Example 20 is the an article of manufacture of example 19 that may optionally include that determining positions of discreet light sources of the scene is performed by triangulation of the discreet light sources detected in the plurality of light probes.

Example 21 is the an article of manufacture of example 19 that may optionally include that the method further comprises measuring total incoming light using an ambient light sensor of the mobile device.

Example 22 is the an article of manufacture of example 19 that may optionally include that the method further comprises determining fall-off characteristics of the plurality of discreet light sources.

Example 23 is the an article of manufacture of example 19 that may optionally include that determining fall-off characteristics of the plurality of discreet light sources comprises fitting a fall-off curve into measurement data indicative of a measure of total incoming light made by an ambient light sensor of the mobile device.

Example 24 is the an article of manufacture of example 19 that may optionally include that registering the different positions and orientations with the mobile device comprises performing on-board tracking with the mobile device.

Example 25 is a processor or other apparatus substantially as described herein.

Example 26 is a processor or other apparatus that is operative to perform any method substantially as described herein.

Example 27 is a processor or other apparatus that is operative to perform any instructions/operations substantially as described herein.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. An apparatus comprising:
an on-board tracking device to obtain a position and an orientation of a mobile device at a number of different times;
one or more image sensors of the mobile device operable to capture a plurality of light probes of a scene from different positions and orientations at the number of different times; and
a light source position determination processor coupled to receive the plurality of light probes and the position and orientation of the mobile device and operable to determine positions of discreet light sources of the scene using the plurality of light probes and the position and orientation of the mobile device.

2. The apparatus defined in claim 1 wherein the light source position determination processor determines positions of discreet light sources of the scene by performing triangulation of the discreet light sources detected in the plurality of light probes.

3. The apparatus defined in claim 1 further comprising an ambient light sensor of the mobile device operable to measure total incoming light using an ambient light sensor of the mobile device.

4. The apparatus defined in claim 1 further comprising a light intensity estimator to determine the light intensity of each of the discreet light sources.

5. The apparatus defined in claim 4 wherein the light intensity estimator determines the light intensity by determining fall-off characteristics of the plurality of discreet light sources.

6. The apparatus defined in claim 5 wherein the light intensity estimator determines the fall-off characteristics of the plurality of discreet light sources by fitting a fall-off curve into measurement data indicative of a measure of total incoming light made by an ambient light sensor of the mobile device.

7. The apparatus defined in claim 1 wherein the on-board tracking device is operable to obtain the different positions and orientations with the mobile device using visual features and one or more cameras.

8. The apparatus defined in claim 1 further comprising:
one or more sensors of a mobile device coupled to the registration device to determine orientation of the mobile device; and
a position device coupled to the registration device to determine position of the mobile device.

9. The apparatus defined in claim 8 wherein the one or more sensors comprises at least one accelerometer and a magnetometer and the position device comprises a global position system (GPS) device.

10. The apparatus defined in claim 1 wherein the mobile device comprises one selected from a group consisting of: a mobile personal computer, a notebook computer, a tablet and a smartphone.

11. A method comprising:
capturing a plurality of light probes of a scene from a number of different positions and orientations of a mobile device, including registering the different positions and orientations with the mobile device; and
determining positions of discreet light sources of the scene using the plurality of light probes.

12. The method defined in claim 11 wherein determining positions of discreet light sources of the scene is performed by triangulation of the discreet light sources detected in the plurality of light probes.

13. The method defined in claim 11 further comprising measuring total incoming light using an ambient light sensor of the mobile device.

14. The method defined in claim 11 further comprising determining fall-off characteristics of the plurality of discreet light sources.

15. The method defined in claim 14 wherein determining fall-off characteristics of the plurality of discreet light sources comprises fitting a fall-off curve into measurement data indicative of a measure of total incoming light made by an ambient light sensor of the mobile device.

16. The method defined in claim 11 wherein registering the different positions and orientations with the mobile device comprises performing on-board tracking with the mobile device.

17. The method defined in claim 11 wherein the light probes are high dynamic range (HDR) images.

18. The method defined in claim 11 wherein the mobile device comprises one selected from a group consisting of: a mobile personal computer, a notebook computer, a tablet and a smartphone.

19. An article of manufacture having one or more non-transitory computer readable storage media storing instructions which when executed by a system causes the system to perform a method comprising:
capturing a plurality of light probes of a scene from a number of different positions and orientations of a mobile device, including registering the different positions and orientations with the mobile device; and
determining positions of discreet light sources of the scene using the plurality of light probes.

20. The article of manufacture defined in claim 19 wherein determining positions of discreet light sources of the scene is performed by triangulation of the discreet light sources detected in the plurality of light probes.

21. The article of manufacture defined in claim 19 wherein the method further comprises measuring total incoming light using an ambient light sensor of the mobile device.

22. The article of manufacture defined in claim 19 wherein the method further comprises determining fall-off characteristics of the plurality of discreet light sources.

23. The article of manufacture defined in claim 22 wherein determining fall-off characteristics of the plurality of discreet light sources comprises fitting a fall-off curve into measurement data indicative of a measure of total incoming light made by an ambient light sensor of the mobile device.

24. The article of manufacture defined in claim 19 wherein registering the different positions and orientations with the mobile device comprises performing on-board tracking with the mobile device.
